(19) United States
(12) Patent Application Publication
(10) Pub. No.: US 2026/0249364 A1
(43) Pub. Date: Aug. 27, 2026

(54) METHOD AND SYSTEM FOR PROCESSING AN AUXILIARY PLATE WITH FASTENERS

(71) Applicant: FCA US LLC, Auburn Hills, MI (US)

(72) Inventors: Hongyu Wang, Shanghai (CN); Junjie Zhou, Shanghai (CN); Haifeng Guo, Shanghai (CN); Zuohong Fu, Shanghai (CN); Xiaozhou Jiang, Shanghai (CN)

(21) Appl. No.: 19/060,887

(22) Filed: Feb. 24, 2025

(51) Int. Cl. B23B 35/00; B23B 11/00

(52) U.S. Cl. CPC B23B 35/00; B23B 11/00; B23B 2215/24

(57) ABSTRACT

A system and method for processing using an auxiliary plate includes an identifier associated with the auxiliary plate. A fastener assembly system configured to compare a process count associated with the auxiliary plate with a process threshold. A warning display is coupled to the fastener system. The fastener assembly system generates a warning at the warning display when the count exceeds the process threshold.

### FIELD

The present disclosure relates to a manufacturing system for assembling components using fasteners, and, more specifically, to a method and system for determining monitoring the useful life of the fastener.

### BACKGROUND

This section provides background information related to the present disclosure which is not necessarily prior art.

In various assembly processes, temporary or auxiliary components may be temporarily assembled to a larger component. One example of this is during the assembly and machining of an engine. A torque plate is one example of a temporary assembly used for an engine. A torque plate is used to simulate the cylinder bores distortion. At the stage the torque plate is used, the cylinder and pistons are not assembled. The machine shop thus hones the cylinders with the simulated distortion to allow better ring seals and compression and thus reduces the original consumption during operation of the vehicle.

### SUMMARY

This section provides a general summary of the disclosure and is not a comprehensive disclosure of its full scope or all of its features.

The present system and method provide a system and method for providing an indicator when the fasteners have used their useful life.

In one aspect of the disclosure, a method includes communicating an identifier from an auxiliary plate to a fastener assembly system, comparing a process count associated with the auxiliary plate with a process threshold and generating a warning display when the count exceeds the process threshold.

In another aspect of the disclosure, a system and method for processing using an auxiliary plate includes an identifier associated with the auxiliary plate. A fastener assembly system configured to compare a process count associated with the auxiliary plate with a process threshold. A warning display is coupled to the fastener system. The fastener assembly system generates a warning at the warning display when the count exceeds the process threshold.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1A is a perspective view of a torque plate used in the present disclosure.

FIG. 1B is a perspective view of the torque plate coupled to a cylinder block.

FIG. 1C is a top view of the torque plate coupled to the cylinder block.

FIG. 2A is a high block diagrammatic view of the manufacturing system.

FIG. 2B is a high level process flow of the manufacturing method.

FIG. 3A is a block diagrammatic view of a torque plate assembly system.

FIG. 3B is an example of a screen display.

FIG. 3C is a block diagrammatic view of the RF device.

FIG. 4 is a flowchart of a method for operating the system.

Corresponding reference numerals indicate corresponding parts throughout the several views of the drawings.

### DETAILED DESCRIPTION

Example embodiments will now be described more fully with reference to the accompanying drawings.

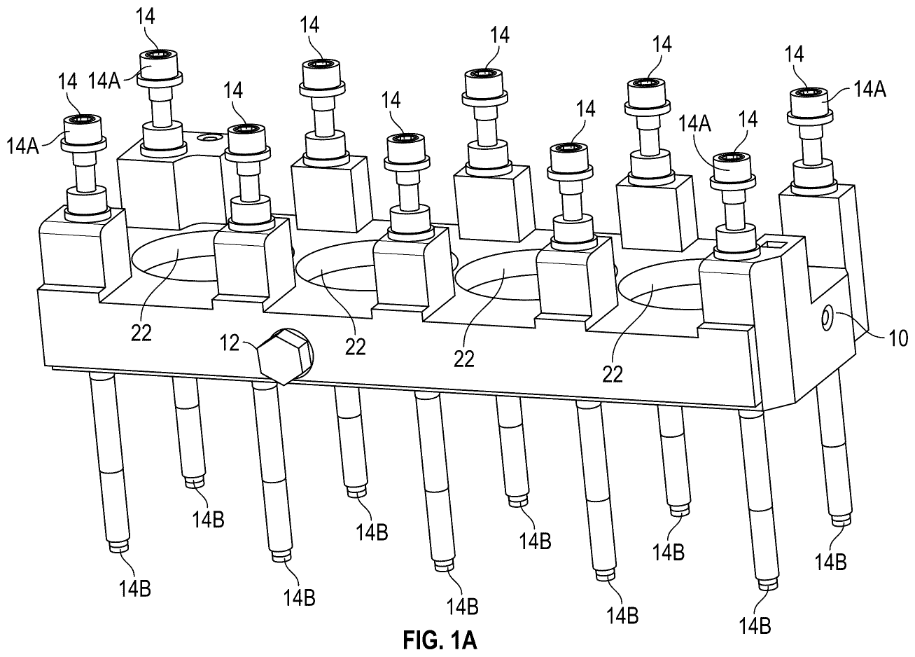

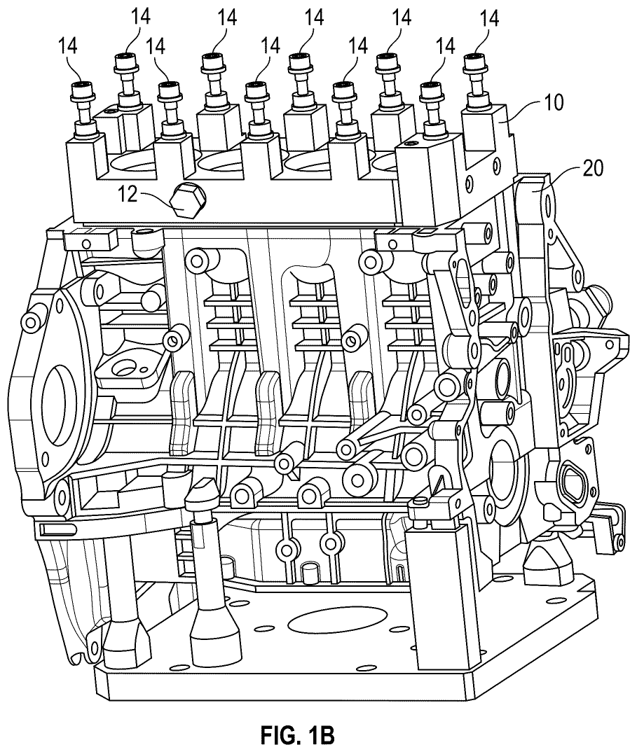

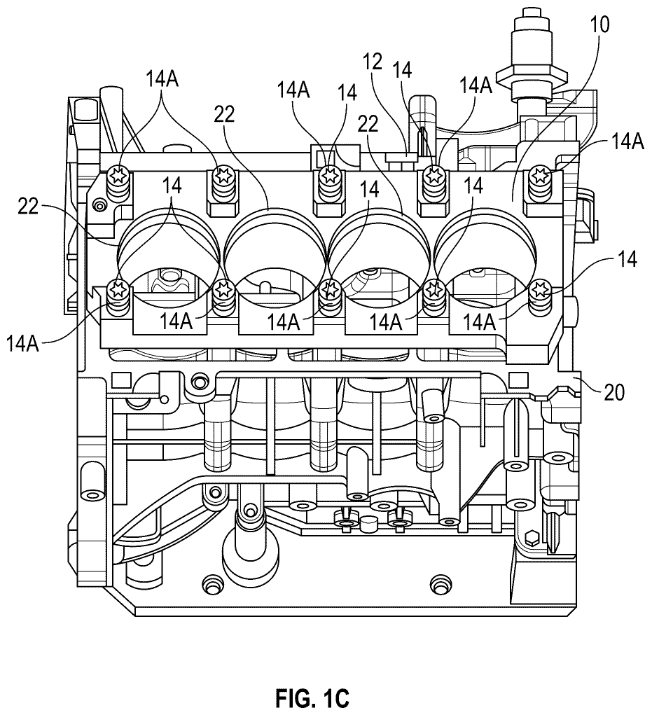

Referring now to FIGS. 1A, 1B and 1C, a torque plate 10 is an example of an auxiliary plate that is used during a manufacturing process. As mentioned briefly above, a torque plate 10 may be used for torquing a cylinder block 20 of an engine during an operation such as honing. The torque plate 10 is recycled so it can be used multiple times during production. The torque plate 10 has an identifier 12 coupled thereto. In this example, the identifier 12 is an RF device that is affixed to the torque plate 10 and generates an RF signal that has a chip that stores the part information, production information and usage cycle (fastener status) information where information is a type of data. Other types of identifiers may be used such as bar codes and the like. The part information is an identifier for the torque plate 10. The torque plate 10 has a plurality of fasteners 14 that extend through openings in the torque plate 10. The fasteners 14 in the present example are bolts that have a head 14A and a shaft 14B extending from the heads 14A. Ultimately, the shafts 14B and threaded portions thereof are coupled to a cylinder block 20. In the present example, ten fasteners 14 are illustrated. However, a greater number for lesser number of fasteners 14 may be used depending upon the type of auxiliary plate used. In the present example, the torque plate 10 has a plurality of openings 22 that allow for honing to take place.

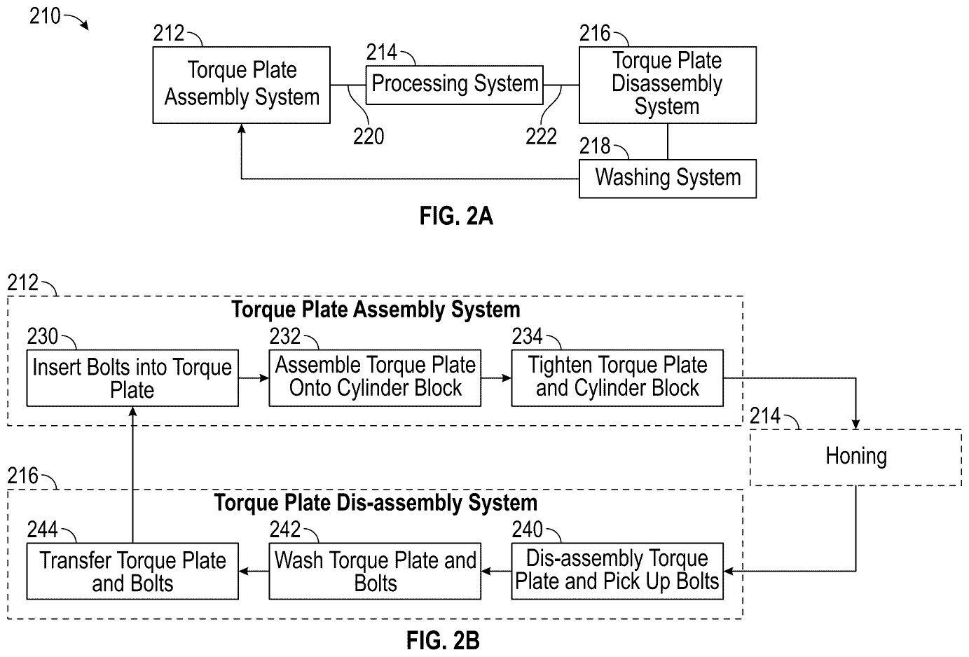

Referring now to FIG. 2A, an example of a processing system 210 is set forth. In this example, a torque plate assembly system 212 is set forth. In this example, the torque plate assembly system 212 assembles or secures the torque plate 10 to the cylinder block 20 from FIG. 1. The torque plate assembly system 212 robotically screws the fasteners 14 into the cylinder block assembly 20. The torque plate assembly system 212 is coupled to a processing system 214. The processing system 214 may be a machining system that is used to perform an action on the items such as the cylinder block. The processing system 214 may be a honing system or another type of machine system.

A torque plate disassembly system 216 is used to remove the torque plate from the processed items such as the cylinder block 20. The torque plate disassembly system 216 may be the same system as the torque plate assembly 212. That is, one system may be provided for both assembly and disassembly, thus systems 216 and 212 may be combined. The torque plate disassembly system 216 rotates the fasteners in the reverse direction to free the fasteners 14 from the cylinder block 20.

A washing system 218 may be used to wash the cylinder block 20 and the torque plate 10 together with the fasteners 14. Ultimately, the removed torque plate and the fasteners 14 are reused by the torque plate assembly system for another cylinder block.

The torque plate assembly system 212 and the processing system 214 may be coupled together by a transport system 220. Likewise, a transport system 222 may be used to couple the processing system 214 and the torque disassembly system 216. The transport system 220 may be a mechanism system such as a robot or a conveyor belt that is used to move the assembly comprising the torque plate and cylinder block in this example.

Referring now to FIG. 2B, a high level flowchart for operating the torque plate assembly system 220 of the present system is set forth. In step 230, the bolts are inserted into a torque plate and the torque plate is assembled onto a cylinder block in step 232. These steps take place in the torque plate assembly system 212 described above. The torque plate assembly system 212 also tightens the torque plate to the cylinder block in step 234 by tightening the fasteners. The system may be an automatic or robotic system that tightens the torque plate to the cylinder block. The processing system 214 is illustrated as a honing system. However, other types of processing for other types of systems may be used. It should be noted that typically a torque plate has the bolts bundled therewith. That is, during the use of the torque plate and the recycling of the torque plate, the bolts stay therewith. In this example, ten fasteners 14 are associated with a torque plate. The torque plate assembly system 212 is an automated tightening station that is used for tightening the ten fasteners to couple the torque plate to the cylinder block. As will be described in greater detail below, the RFID system and the RF device will record and increment the counter. Before operating, the counter may be checked to make sure the bolts have not been tightened too many times.

In step 240, disassembly of the torque plate and the fasteners is performed using the torque plate disassembly system 216. In step 242, the torque plate and bolts may be washed in the washing system 218 as illustrated above. In step 244, the torque plate and the bolts are transferred to the beginning of the process and into the torque plate assembly system 212. However, a display, as will be described in greater detail below, may be used to signal that the fasteners have been used, greater than a process threshold amount of a predetermined amount of times.

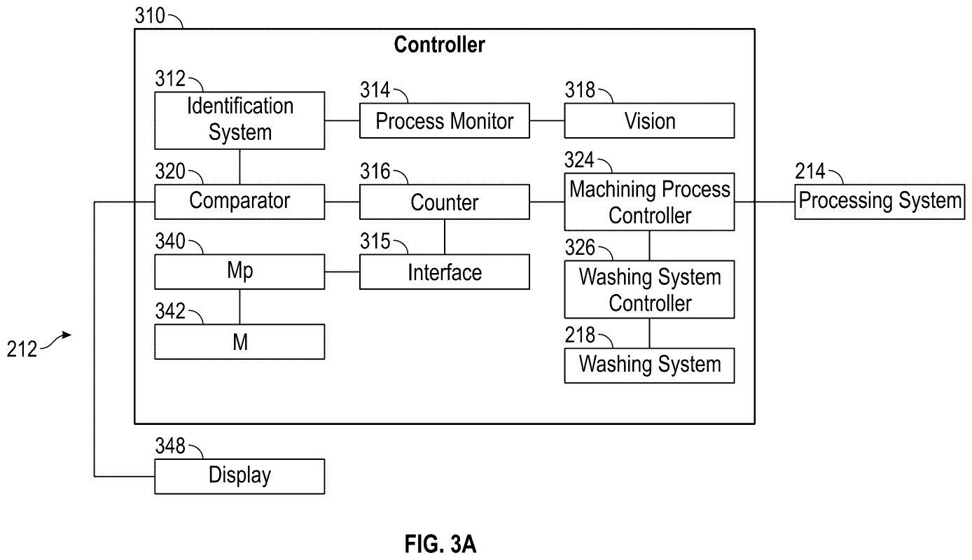

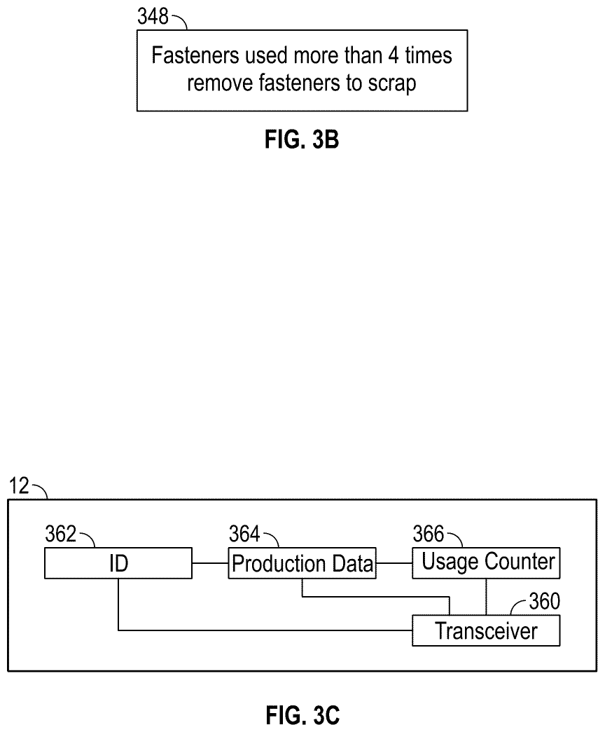

Referring now to FIG. 3A, a block diagrammatic view of a disassembly system or an assembly system 212, 216 is set forth. Each system may be configured in a similar manner. The systems, as mentioned above, may be the same system depending on the desired throughput of the process. Should rapid processing be desired, the systems may be separated into the assembly system and the disassembly system as illustrated in FIG. 2B.

In FIG. 3A, a controller 310 is used for performing various steps within the process. The controller 310 may provide an identification system 312. The identification system 312 may intercommunicate through an interface 315, such as an antenna, with the identifier 12 such as the RF device. A query signal may be generated. In response to the query signal, the system may obtain various data including data signal that include an identifier, production data and a fastener status such as a usage count that is stored within the identifier 12 or RF device. The identification system communicates with a process monitor 314. The process monitor 314 may be used for monitoring various processes and control the various processes in an automated fashion. For example, the processing monitor 314 may control the torque plate assembly system 212, the torque plate disassembly system 216, the honing or processing system 214, the washing system 218 and the transport systems 220, 222. The process monitor 314 is in communication with a counter 316. The counter 316 may store the identification as well as the number of usages for the torque plate and therefore the fasteners. The counter 316 may also communicate with the user interface 315 to communicate a count or an increase in a count to the RF device illustrated above.

The controller 310 may also include a comparator 320. The comparator 320 may compare the number of times the process has been performed with a process threshold. In the present example, the fasteners are to be used no more than five times. This amount was experimentally determined for a single set of torque plates and cylinders.

The controller 310 may also have a machining process controller 324. The machining process controller 324 may be used for controlling the processing system 214. Likewise, the controller 310 may also include a washing system controller 326. The washing system controller 326 may be used to control the starting, stopping and other factors of the washing system 218.

The system may be microprocessor or processor based and have one or more processors 340 therein. The microprocessor 340 may have a memory 342 associated therewith. The memory 342 may be used to store various perimeters commands. The memory 342 is a non-transitory computer-readable medium that includes machine-readable instructions that are executable by the processor 340. The machine-readable instructions may include instructions for controlling a display 348 that is used for displaying instructions or a warning message as will be described in greater detail below. The instructions may also include instructions for controlling the machine process controller 324, the washing system controller 326 and the process monitor 314. The controller 310 may also be referred to as a programmable logic controller.

A vision system 318 may be disposed within the controller 310. The vision system 318 may allow the system to monitor various processes as well as provide identification. For example, the torque plate 10 may have a bar code rather than a RF identifier. The vision system 318 may be used to read the bar code that may engraved on the side of the torque plate. Physically engraved numbers may also be used to identify the torque plates.

Referring now to FIG. 3B, one example of a display message at a display 348 is set forth. In this example, the display indicates that the “fasteners” have been used more than a process threshold amount of times by displaying “fasteners using more than four times remove fasteners to scrap”. Of course, various warning display messages may be provided.

Referring now to FIG. 3C, the RF device may include a transceiver 360 that is used for transmitting and receiving data to and from the controller 310. The transceiver 360 may communicate through the interface 315 of FIG. 3A with the controller. The transceiver 360 may communicate an identification, such as an identification number, that is stored within a memory 362. Production data may be communicated from a production data memory 364. A usage counter 366 may be associated with the number of times or processes that the torque plate and the associated fasteners have been used. That is, when the bolts have been used more than a predetermined number of times, such as four or five times, the bolts are to be scrapped.

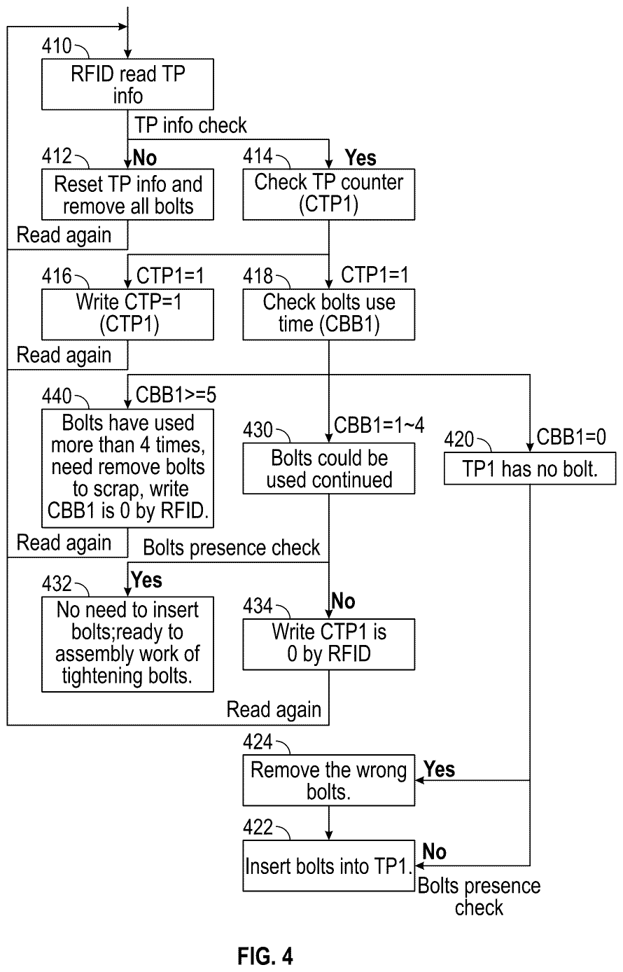

Referring now to FIG. 4, a method for operating the torque plate assembly and disassembly is set forth. In the figure, TP stands for torque plate, CTP=1 means that 1 #TP bolts have already been inserted in the 1 #TP and CBB =1, the bolts used time counter where the data in this example is 0-5. In step 410, the RF device communicates the torque plate data to the controller 310 illustrated above. The controller 310 may receive an identifier, production data and a usage counter. When no information is received, the torque plate and the RF device associated with the torque plate may be reset. All the fasteners or bolts may be removed in step 412. In step 410, when the RF ID receives data, step 414 checks the torque plate counter. The counter is determined whether it is not 1 or it is 1. As mentioned above, CTP1=1 means the bolts have been inserted into a torque plate. If the fasteners have not been inserted into a torque plate, step 416 is executed which writes a 1 into the memory to indicate that the fasteners are being inserted. The system repeats in step 410. That is, step 416 is an indication that the bolts have not been used and are about to be reused. The system re-executes steps 410 and 414. In step 418, when CTP1=1. Step 418 checks the use time of the bolts or the count CBB1. That is, the data may start at 0 and extend all the way to 1. When CBB1=0, step 420 determines whether there is a bolt present. After step 420, step 422 is performed when no bolts are present. That is, the bolts may be then inserted into the torque plate. In step 420, when bolts are present, the wrong bolts are being used and must be removed in step 424. Thereafter, the proper bolts are inserted in step 422.

In step 418, when CBB is between 1 and 4, step 430 is performed. In step 430, the bolts ae proper and may continue to be used because they are not over the process threshold value. After step 430, if the bolts are present, step 432 is performed in which there is no need to insert bolts that assembly is ready to tighten the bolts. If after step 430, when there are no bolts present, step 434 writes CTP1 is 0 to indicate no bolts are present. The system repeats after step 434 to step 410.

In step 418, when the bolts have been used greater than 5 (that is, CBB≥5, an indicator is generated in step 440. The indicator generated in step 440 may provide an indication that the bolts have been used more than four times and may need to be scrapped. CBB1 is written to be 0 at the RF device.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. 1steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A method comprising:
communicating an identifier from an auxiliary plate to a fastener assembly system;
comparing a process count associated with the auxiliary plate with a process threshold; and
generating a warning display when the count exceeds the process threshold.

2. The method of claim 1 wherein prior to communicating the identifier, generating a query signal at a fastener assembly system and wherein communicating the identifier comprise communicating the identifier in response to the query signal.

3. The method of claim 1 wherein communicating the identifier comprises communicating the identifier from a torque plate.

4. The method of claim 1 wherein communicating the identifier comprises communicating the identifier from an RF device affixed to a torque plate.

5. The method of claim 1 wherein communicating the identifier comprises communicating the identifier using a vision system.

6. The method of claim 1 further comprising determining a fastener status.

7. The method of claim 1 wherein comparing the process count comprises comparing the process count to a process threshold of 5.

8. The method of claim 1 further comprising determining a presence of fasteners.

9. The method of claim 8 wherein when fasteners are present, tightening the fasteners.

10. The method of claim 9 wherein tightening the fasteners comprises tightening the fasteners to secure a torque plate to a cylinder block.

11. The method of claim 10 further comprising after tightening the fasteners to secure the torque plate to the cylinder block, honing the cylinder block.

12. The method of claim 11 further comprising disassembling the torque plate from the cylinder block after honing.

13. The method of claim 12 further comprising thereafter washing the torque plate and the fasteners.

14. The method of claim 13 further comprising incrementing the process count.

15. The method of claim 8 further comprising after tightening the fasteners, performing a process.

16. A system comprising:
an auxiliary plate comprising an identifier;
a fastener assembly system configured to compare a process count associated with the auxiliary plate with a process threshold; and
a warning display coupled to the fastener system, the fastener assembly system generating a warning at the warning display when the count exceeds the process threshold.

17. The system of claim 16 wherein the identifier comprises an RF identifier.

18. The system of claim 16 wherein the identifier comprises a bar code.

19. The system of claim 16 wherein the auxiliary plate comprises a torque plate and the fasteners comprise bolts and further comprising a cylinder block, wherein the fastener assembly system fastens the torque plate to the cylinder block with the bolts when the process count is below the process threshold.

20. The system of claim 19 further comprising a transport system moving the cylinder block to a processing system when the process count is below the process threshold.
